(19) United States
(12) Patent Application Publication
(10) Pub. No.: US 2016/0071086 A1
(43) Pub. Date: Mar. 10, 2016

(54) Method and System for Facilitating a Transaction

(71) Applicant: MasterCard International Incorporated, Purchase, NY (US)

(72) Inventors: Daniel James Malone, Dublin (IE); Angela Kravcevich, Dublin (IE)

(21) Appl. No.: 14/844,166

(22) Filed: Sep. 3, 2015

(30) Foreign Application Priority Data
Sep. 4, 2014 (GB) 1415661.6

(51) Int. Cl. G06Q 20/32; G06Q 20/02

(52) U.S. Cl. CPC G06Q 20/3224; G06Q 20/027

(57) ABSTRACT

A computer-implemented method of processing a payment at a network node is described. The method includes operating a processor to identify a set of agreed purchase parameters, the agreed purchase parameters including data indicative of a purchase location, a purchase amount, a first device associated with a first user, and a second device associated with a second user, determine a first location of the first device, determine a second location of the second device, and responsive to determining that the first location and the second location are within a predefined distance from the purchase location, effecting a transfer of the purchase amount from a first account associated with the first user to a second account associated with the second user.

### CROSS REFERENCE TO RELATED APPLICATIONS

This application claims the benefit of GB Patent Application No. 1415661.6 filed Sep. 4, 2014, which is hereby incorporated by reference in its entirety.

### BACKGROUND OF THE DISCLOSURE

This invention relates to systems and methods for facilitating a transaction. More particularly, it relates to a method and system for facilitating secure peer-to-peer transactions.

Digital noticeboards are popular for buying and selling used items, for example bicycles or books. However, security and safety for the parties involved in any transactions is a significant problem.

In particular, to purchase an item from an online noticeboard, a user is required to contact the seller and arrange an exchange or handover of the money and goods. This scenario is undesirable as the seller and/or the buyer must trust the other party despite the fact that they may be complete strangers. For example, the seller must trust that the buyer has access to the necessary funds to purchase the sales good and, more importantly, that the buyer will hand over the agreed amount of money on receiving the sale goods. Similarly, the buyer must trust that the sale goods match the sale description and that the seller will hand over the goods on receipt of the buyer's money.

In view of the risk attached to such transactions, it would clearly be desirable to provide a method of facilitating secure peer-to-peer transactions, in which the parties involved are not required to ‘blindly’ trust each other.

### BRIEF DESCRIPTION OF THE DISCLOSURE

In accordance with a first aspect of the present disclosure, there is provided a computer-implemented method of processing a payment at a network node. The method includes operating a processor to identify a set of agreed purchase parameters, the agreed purchase parameters including data indicative of a purchase location, a purchase amount, a first device associated with a first user, and a second device associated with a second user, determine a first location of the first device, determine a second location of the second device, and responsive to determining that the first location and the second location are within a predefined distance from the purchase location, effecting a transfer of the purchase amount from a first account associated with the first user to a second account associated with the second user.

In one embodiment, the processor is operated to effect the transfer of the purchase amount only if the first location is further determined to be within a predefined distance of the second location.

In another embodiment, the agreed purchase parameters further include data indicative of a purchase time, and wherein the processor is operated to effect the transfer of the purchase amount only if a current time is within a predefined period of the purchase time.

In another embodiment, the processor is operated to effect the transfer of the purchase amount only if an indication to proceed is received from the first device.

In another embodiment, operating the processor to effect a transfer of the purchase amount from the first account to the second account includes operating the processor to determine a payment provider associated with the first account, and transmit, to the determined payment provider, a request for payment of the purchase amount to the second account.

In a further embodiment, the processor is further operated to determine that the purchase amount has been transferred from the first account to the second account, and output an indication that the payment has been completed.

In one embodiment, the processor is operated in association with an application being executed on at least one of the first device and the second device, wherein operating the processor to output an indication that the payment has been completed includes operating the processor to transmit an application notification to the at least one of the first device and the second device.

In one embodiment, the data indicative of a purchase location includes data indicative of at least one of: a transport route, a roadway, and a geographical region.

In one embodiment, the agreed purchase parameters further include data indicative of the account associated with the first user and the account associated with the second user.

In another embodiment, the data indicative of at least one of the first account and the second account includes an account number. The account number may be a virtual card number.

In one embodiment, prior to identifying a set of agreed purchase parameters, determining a first location, determining a second location, and effecting a transfer, the method includes operating a processor to receive a sale offer from a device associated with the second user, the sale offer including data indicative of an object for sale, a requested sale amount, and a requested sale location, and output data indicative of the received sale offer.

In another embodiment, the method includes operating the processor to receive, in response to the sale offer, a purchase request from a device associated with the first user, the purchase request including data indicative of an offer amount and a requested purchase location, transmit the purchase request to the device associated with the second user, and receive, from the device associated with the second user, an indication of acceptance of the purchase request, wherein to identify a set of agreed purchase parameters, the processor is operated to identify the set of agreed purchase parameters in accordance with the accepted purchase request.

In one embodiment, prior to identifying a set of agreed purchase parameters, determining a first location, determining a second location, and effecting a transfer, the method includes operating a processor to receive a set of required purchase parameters from a device associated with the first user, the required purchase parameters including data indicative of at least one of a required object, a required purchase amount, and a required purchase location, identify at least one sale offer determined to match the set of required purchase parameters; and transmit, to the device associated with the first user, a communication including data indicative of the identified at least one sale offer, wherein the sale offer is determined to match a set of purchase parameters if at least one of an identifier of an object included within the sale offer is determined to be the same as an identifier of the required object, an amount indicated in the sale offer is within a predefined range of the required purchase amount, and a location indicated in the sale offer is within a predefined distance of the required purchase location.

In another example, the processor is operated in association with an application being executed on the device associated with the first user, and wherein the communication including data indicative of the identified at least one sale offer includes an application notification.

In a second aspect of the present disclosure, there is provided a network node operable to process a payment. The network node includes a processor configured to (a) identify a set of agreed purchase parameters, the agreed purchase parameters including data indicative of a purchase location, a purchase amount, a first device associated with a first user, and a second device associated with a second user, (b) determine a first location of the first device, (c) determine a second location of the second device, and (d) responsive to determining that the first location and the second location are within a predefined distance from the purchase location, effecting a transfer of the purchase amount from a first account associated with the first user to a second account associated with the second user.

In a third aspect of the present disclosure, a computer-readable medium including instructions is provided. When executed, the instructions cause a processor operating a network node to implement a method of processing a payment at a network node. The method includes operating a processor to identify a set of agreed purchase parameters, the agreed purchase parameters including data indicative of a purchase location, a purchase amount, a first device associated with a first user, and a second device associated with a second user; determine a first location of the first device, determine a second location of the second device, and responsive to determining that the first location and the second location are within a predefined distance from the purchase location, effecting a transfer of the purchase amount from a first account associated with the first user to a second account associated with the second user.

### BRIEF DESCRIPTION OF THE DRAWINGS

FIG. 1 is a diagram of a system according to an example embodiment.

FIG. 2 is a flow diagram depicting a method of registering a user to use the system according to an example embodiment.

FIG. 3 is a flow diagram depicting an example method of facilitating a transaction according to an example embodiment.

FIG. 4 depicts an example method of facilitating a transaction according to an example embodiment.

FIG. 5 depicts a method of effecting a payment according to an example embodiment.

FIG. 6 depicts a communication sequence in accordance with an example embodiment.

### DETAILED DESCRIPTION OF THE DISCLOSURE

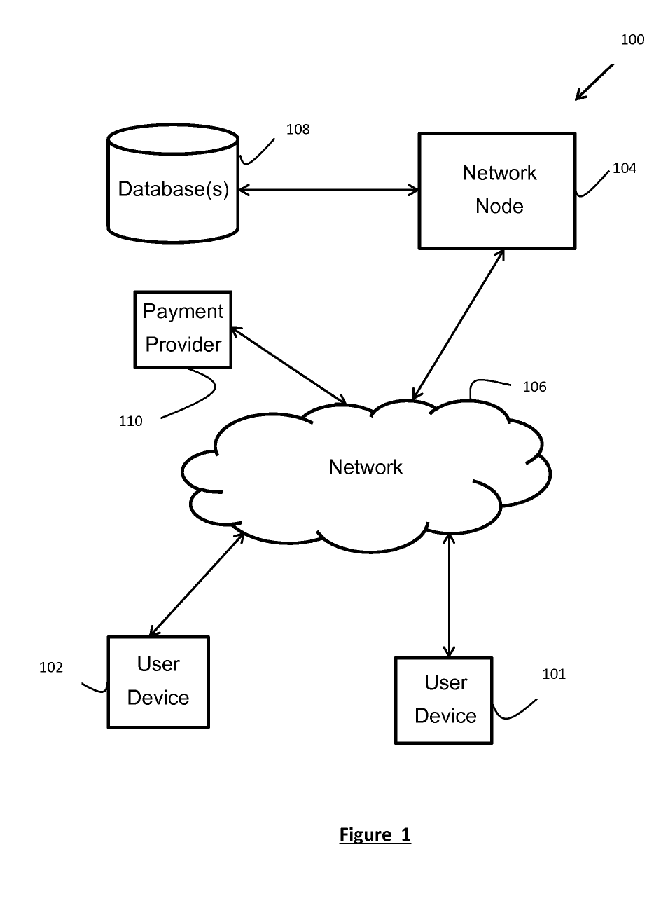

Referring to the drawings and, in particular to FIG. 1, an example system 100 for facilitating peer-to-peer transactions is shown.

The system 100 includes at least two user devices 101 and 102 capable of, or adapted to, transmit communications to, and to receive communications from, a network node 104 over a network 106. It will be appreciated that each of the user devices 101, 102 itself includes a network node and is differentiated from the network node 104 in the following for ease of explanation only.

One or both of the at least two user devices 101, 102 may include a portable computing device (e.g. a laptop computer, a smartphone, a tablet computer etc.); a desktop computer; or any other suitable device. In an example embodiment, one or both of the at least two user devices 101, 102 is running (or ‘executing’) a software application or ‘app’ which, when executed by a processor of the user device 101, 102, causes the processor to perform the process steps described below.

The network node 104 may include, or be included within, any suitable device. For example, the network node 104 may include, or be included within, a remote server. Additionally or alternatively, the network node 104 may be included within a base station. In what follows, the network node 104 will be referred to as a single node within the system 100. However, it will be appreciated that the network node may include multiple individual nodes at which the request is processed and/or re-transmitted. In an example embodiment, the network node 104 is a server operating in association with a software application or ‘app’ that is running (or being executed) on one or both of the user devices 101, 102.

The network node 104 may be configured to communicate with one or more respective databases 108 via a wired and/or a wireless connection. For example, the network node 104 may write data to the one or more databases 108. Additionally or alternatively, the network node 104 may retrieve data stored in, or accessible to, the database 108.

The network node 104 may be an ‘acquirer network node’ that is associated with (linked to, operated on behalf of, included within a system of, etc.) a financial institution that processes (or facilitates) card payments made to a merchant or provides any other financial services. Additionally or alternatively, the network node 104 may be one or more of a network node associated with (linked to, operated on behalf of, etc.) a payment provider 110 (or card issuer); and/or a card payment network node associated with a third party operating as, or in association with, a payment provider 110.

In what follows, the method steps are described as being performed by the network node 104. However, it will be appreciated that these steps may be performed by other elements of the system 100; or by one or more processors included within, or operated by, the network node 104 and/or other elements of the system 100.

The at least two user devices 101, 102 and the network node 104 may communicate using any suitable means. For example, the user devices 101, 102 and the network node 104 may communicate using one or more of Bluetooth™; Near-Field Communication (NFC); Infra-Red (IR) Communication; and Magnetic Induction.

The network 106 may include any network across which communications can be transmitted and received. For example, the network 106 may include a wired or wireless network. The network 106 may, for example, include one or more of: the internet; a local area network; a radio network such as a mobile or cellular network; a mobile data network or any other suitable type of network. In one embodiment the user device 102 communicates over the internet with the network node 104 operating on ‘a cloud’.

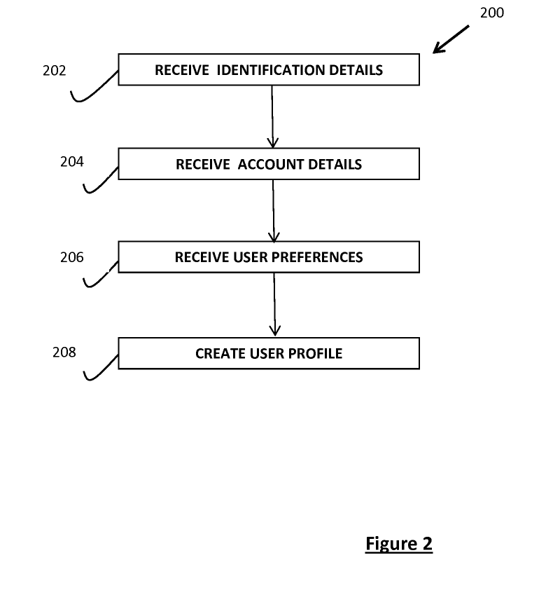

FIG. 2 depicts an example method 200 of registering a user to use the system 100 in accordance with an example embodiment. It will be appreciated that in embodiments of the disclosure, some steps of the registration process may be combined and/or omitted. Similarly, individual steps of the registration process may be performed at different stages. For example, a user may provide a subset of the information when first registering to use the system 100. The user may then provide additional information during subsequent use of the system 100, e.g. when posting a sale offer and/or making a purchase request. Additionally or alternatively, the network node 104 may determine further information about the user based on the user's actions, e.g. the information viewed by the user, and store this information in association with the user registration details.

At step 202, the network node 104 receives identification details pertaining to a user wishing to use the system. The identification details may include any suitable details pertaining to the user such as any one or more of: name, address, date of birth, contact number, email address, username etc. In some embodiments, in order to increase security and/or meet regulatory requirements, the received identification details include copies of formal identification documents such as a passport or driving license.

The user may input the details via any suitable interface. For example, the registration interface may be provided online via a provider website (not shown), via a telephone service, in person etc. In some embodiments, a processor of the device 101, 102 executes a software application or ‘app’ associated with the network node 104 and the user inputs the registration information via a user interface of the app.

At block 204, the network node 104 receives information pertaining to an account associated with the user. The details received at step 204 include information required to authorize a payment from the user account and/or to lodge payments to the user account. In some embodiments, the account detail provided at block 204 includes information pertaining to a debit or credit card registered to (owned by or associated with) the user. In particular, the received details may include a card number or other identifier associated with the user's account. The card number or identifier may be referred to as a Primary Account Number (PAN). The number included within the received details may be a number of a physical (regular or actual) credit and/or debit card, e.g. a number printed on a cardholder's card and linked to a cardholder's account.

The number included within the request may additionally or alternatively be a virtual card number (a dynamic credit card number, a controlled payment number, an alias number, a one-time use credit card number, a substitute credit card number, a rechargeable credit card number etc.). A virtual card number is generated by a card issuer and is linked to at least one physical card number and account. The virtual card number may, for example, be generated via a Web application or a specialized client program provided by, or associated with, an issuer of the physical card number to which the virtual card number is linked.

Additionally, the details received at step 204 may include information indicative of one or more of: a billing address; a payment provider 110 associated with the card; the expiry date of the card; the issue date of the card; the credit card verification (CCV) number of the card; and a response to a security question previously set by the user.

In some embodiments, the received account details include information pertaining to a virtual account, e.g. an account relating to a virtual currency and/or an online ‘wallet’.

At block 206, the network node 104 receives an indication of one or more user preferences. The user preferences may include any parameters defining an object/service that the buyer wishes to purchase and the manner in which the buyer wishes to complete the transaction. For example, the user preferences may include an indication that the user wishes to sell and/or buy items. Additionally or alternatively, the user preferences may be indicative of one or more of: an item/object of interest to the user; a price range of interest to the user; a location or area within which the user is prepared to travel to complete a transaction; one or more devices associated with the user; and any other suitable parameters defining transactions in which the user may be interested. The user preferences may be modified and/or further user preferences may be added at any stage.

In an example embodiment, a user wishing to buy a specific object transmits from his/her device an indication of the required object together with an indication of one or more of: a price (or range of prices) that the buyer is willing to pay for the object; a location (or range of locations) at which the buyer is willing to complete the purchase; a device that the user will use to complete the transaction; and any other characteristics of a required object and/or a sale offer pertaining thereto.

At block 208, the network node 104 creates a user profile including parameters defined in accordance with the information received at steps 202 to 206. The network node 104 may store the created profile in the database 108. As will be discussed in more detail below, the network node 104 uses the profile parameters to match a user with corresponding sale and/or purchase offers received from other users; and/or to facilitate any resulting transactions between the users.

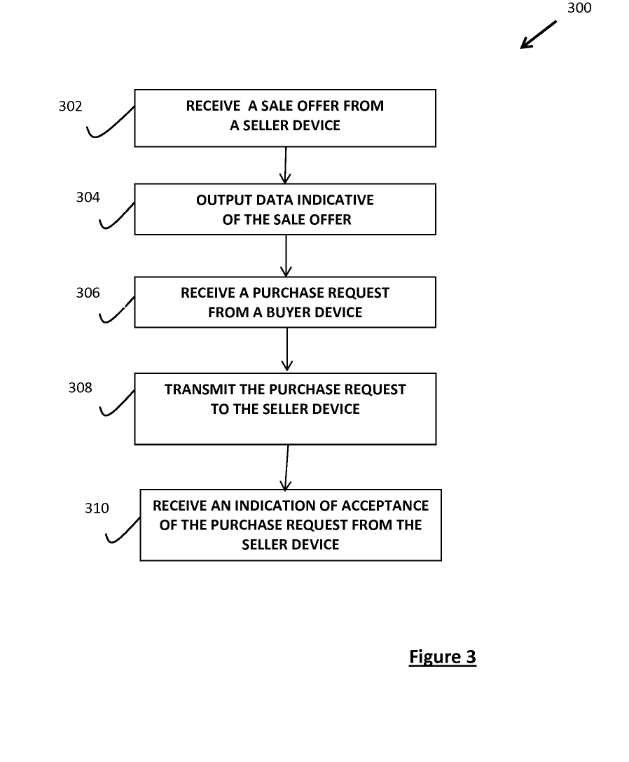

FIG. 3 depicts an example method 300 of facilitating a transaction between a seller and a buyer in accordance with an example embodiment.

At block 302, the network node 104 receives a sale offer from a device 101 associated with a user. For ease of explanation this user will be referred to in what follows as the seller. In some embodiments, prior to transmitting the sale offer to the network node 104, the seller “logs in” or provides authentication information to enable the network node 104 to identify a user profile related to the user, e.g. a profile created during the registration process 200.

The sale offer includes data indicative of one or more sale parameters including: an object for sale; a desired/requested/suggested price (or sale amount); and a desired/requested/suggested location at which the sale can be completed, i.e. a location at which the sale object can be ‘handed over’ from the seller to the buyer. The sale parameters may include an indication of an account associated with the seller and into which the seller wishes to receive money received from the sale. Additionally or alternatively, account details may be indicated by the seller during a registration step so that money from all subsequent sales is received in the indicated account.

In an example embodiment the indication of the object for sale includes an image, e.g. a photo, of the object. The indication of the object for sale may additionally or alternatively include a text description and/or a hyperlink to a description of the object. In some embodiments the requested sale amount may include a specific price, e.g. [symbol] 100. Additionally or alternatively, the requested sale amount may include a range of prices, e.g. [symbol] 100- [symbol] 150.

Similarly, the requested sale location may be a specific location, indicated for example by a postal address or a known point of interest (e.g. a train station, hospital, shopping centre etc.). Additionally or alternatively, the requested sale location may be a range of locations indicated for example, by a range of postal addresses; a transport route; a proximity to a transport route; and/or any other suitable indication. In an example embodiment, the seller indicates that she/he is willing to complete the transaction (‘hand over’ the sale goods) at any location within a specified time and/or distance of a transport route. For example, the seller may indicate that he is willing to complete the transaction at any location that is within a 10 minute walk of a specified bus route.

In some embodiments, the sale parameters include an indication of a device 101 that the seller intends to use to complete the transaction. The device 101 indicated by the seller may be the device from which the sale offer is transmitted to the network node 104. Alternatively, the device indicated by the seller may be any other suitable seller device 101. For example, the sale offer may be received from a desktop computer and the indicated device may be a portable device that the seller intends to bring with him when completing the transaction. In some embodiments, as discussed in relation to FIG. 2, one or more devices 101 may additionally or alternatively be indicated by the seller during the registration process.

At block 304, the network node 104 outputs data indicative of the received sale offer. The data output by the network node 104 may be indicative of some or all of the parameters of the received sale offer and may be output in any suitable manner. In an example embodiment, the network node 104 outputs a selectable thumbnail image and/or title of the object for sale, wherein selection of the thumbnail and/or title results in the output of more details pertaining to the sale offer.

For example, the network node may output a thumbnail image of a bicycle offered for sale wherein selection of the image (e.g. by a potential buyer) causes the network node 104 to output further details provided in the sale offer, e.g. the requested price; the location(s) at which the transaction can be completed; a text description of the condition of the bicycle; and/or any other information provided by the seller. Additionally or alternatively, the network node 104 may output information pertaining to the seller and/or any other information determined to be related to the sale offer. For example, the network node 104 may output reviews provided by previous buyers in relation to the seller and/or the object for sale. In this manner a user can view offers of objects for sale e.g. by browsing through the output offers and/or filtering the available offers using one or more keywords or search terms.

In some embodiments, the network node 104 may additionally notify a device 102 associated with a registered user profile of the sale offer. For example, the network node 104 may identify one or more user profiles including a parameter determined to match a parameter of the sale offer and transmits details of the sale offer to a corresponding user device. In an embodiment in which the buyer device 102 is running an ‘app’ or application software associated with the network node 104, the network node 104 may transmit these details via an application ‘notification’. Additionally or alternatively, the network node 104 may notify a user of details of the identified sale offers in any other suitable manner, e.g. by SMS, telephone call, email etc.

After outputting data indicative of at least one sale offer, at block 306 the network node 104 receives a purchase request from a user device 102 (referred to in what follows as a buyer device) in response to the sale offer. The purchase offer includes data indicative of one or more requested purchase parameters including: an offer amount (or price); a requested purchase location; a buyer device 102; and a buyer account.

As with the sale offer, the offer amount may be a specified price, e.g. [symbol] 100 and/or a range of prices e.g. [symbol] 100- [symbol] 150. In some embodiments, the offer amount indicated by the buyer may be the same as the requested sale amount indicated in the sale offer. Alternatively, it may be an amount greater or less than the amount indicated in the sale offer. For example, the buyer may ‘bargain’ with the seller by offering a lower price for the object than the seller requests in the sale offer. Similarly, the requested purchase location may be a location indicated in the sale offer and/or a further location not indicated in the sale offer but which they buyer wishes to ‘suggest’ to the seller.

At block 308, the network node 104 transmits an indication of the purchase request to the seller device 101. The network node 104 may transmit the indication in any suitable manner. For example, the network node 104 may transmit an email, SMS, telephone call, app notification or any other suitable communication to the seller device 101.

On receipt of the purchase request indication, the seller considers the offer details and decides whether or not to accept the offer. If the seller does not wish to accept the purchase request, the seller device 101 transmits an indication of rejection to the network node 104. The network node 104 then communicates the rejection to the buyer device 102. It will be appreciated that, in some embodiments, if the network node 104 does not receive an indication of acceptance of the purchase request from the seller device 101 within a predefined period of transmitting the purchase request to the seller device 101, the network node 104 determines that the offer has been rejected.

On the other hand, if the seller decides to accept the purchase request, at block 310 the network node 104 receives an indication of acceptance from the seller device 101. The indication of acceptance may be transmitted by the seller device 101 in any suitable manner, e.g. using any one or more of an email; SMS; an ‘app’ notification etc. In some embodiments, the indication of acceptance includes an indication of a device 101 which the seller intends to use to complete the transaction. This indicated device 101 may be the device from which the seller transmits the indication of acceptance and/or any other suitable device.

Subsequent to receiving the indication of acceptance from the seller device 101, the network node 104 may invite the buyer to transfer the agreed purchase amount from the buyer account to a central or ‘holding’ account. In this manner, the network node 104 can ensure that the buyer has the necessary money to complete the transaction before the seller meets the buyer to hand over the sale goods.

In some embodiments, subsequent to receiving the indication of acceptance, the network node 104 transmits a payment request to a payment provider 110 associated with the buyer and/or the buyer account. As discussed in relation to FIG. 2, details of the payment provider 110 and/or the buyer account may, for example, be provided by the buyer during a registration process. Additionally or alternatively, the network node 104 may receive account and/or payment provider details with the purchase request at block 306.

Responsive to receiving the request from the network node 104, the payment provider 110 may place a ‘hold’ or ‘reserve’ the indicated purchase amount from the buyer's account. In this manner, the agreed purchase amount is not transferred out of (i.e. taken or deducted) from the buyer's account. In this manner, the payment provider 110 can provide confirmation to the network node 104 that the buyer has sufficient funds to make the payment whilst maintaining the buyer's security.

Additionally or alternatively, responsive to receiving the request from the network node 104, the payment provider 110 may transfer the agreed purchase amount from the buyer's account to an ‘intermediary’ or ‘holding’ account associated with the network node 104.

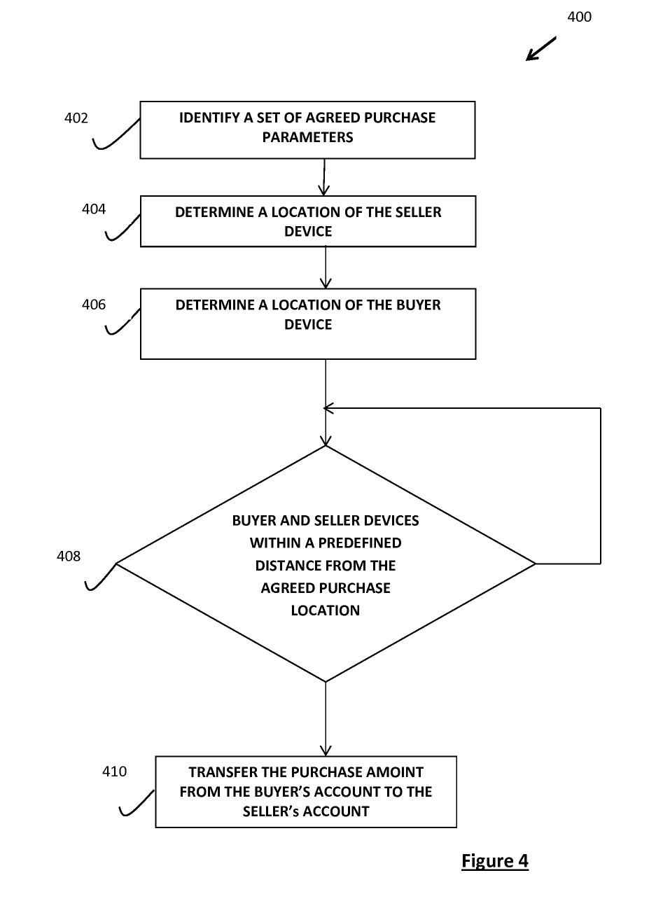

FIG. 4 depicts a method 400 of facilitating completion of an agreed transaction in accordance with an example embodiment. At block 402, the network node 104 identifies a set of purchase parameters that have been agreed by both the buyer and the seller. For example, the set of agreed purchase parameters may be the set of parameters indicated in the purchase request at block 306 and for which an indication of acceptance was received at block 310.

As discussed above, the agreed purchase parameters may include any suitable parameters defining the manner in which the transaction is to be completed. In an example embodiment, the agreed purchase parameters include data indicative of a purchase location or area; a purchase amount; a seller account and a buyer account. The indication of the seller account and/or the buyer account may be one or more of: a payment card number or Personal Account Number (PAN); a virtual account number; or any other identifier of an account associated with the respective user.

In some embodiments, the agreed purchase parameters include an indication of an identity of one or both of a seller device 101 and a buyer device 102 that will be used to complete the transaction. Additionally or alternatively, the seller and/or the buyer may ‘log on’ or ‘sign-in’ to complete the transaction, i.e. the seller and/or the buyer may provide any necessary information for the network node 104 to identify a respective associated profile. Responsive to receiving and/or validating this information, the network node 104 may determine the identity of each user device to be the device from which the respective user information was received.

At block 404 the network node 104 determines a location of the seller device 101; and at block 406 the network node 104 determines a location of the seller device 102. The network node 104 may determine the locations of the seller and buyer devices in any suitable manner. For example, the network node 104 may determine the location of one or both of the devices using any one or more of: multilateration of radio signals; GPS; Wi-Fi positioning; triangulation etc. In an embodiment in which the seller device 101 and the buyer device 102 are executing an ‘app’ or software application associated with the network node 104, the app software may cause the transmission of the location of the respective device to the network node 104.

At block 408 the network node 104 then determines the location of the seller device 101 and the buyer device 102 and determines whether these locations are both within a predefined distance from the purchase location indicated in the agreed purchase parameters. In some embodiments, the network node 104 additionally checks that the buyer and seller devices are within a predefined distance of each other before transferring the money.

Responsive to determining that one or both of the buyer device 101 and the seller device 102 are not within a predefined distance of the agreed purchase location, the network node 104 may wait for a predefined period before repeating the steps at block 408. In this case the network node 104 may repeat the steps at block 408 a predefined number of times and/or for a predefined period. If during these repetitions, the seller and buyer devices are not determined to be within a predefined distance of the agreed purchase location, processing ends without completion of the transaction. In embodiments in which a ‘hold’ had been placed on the purchase amount in the buyer's account, the network node 104 instructs the payment provider 110 to release these funds. Similarly, in embodiments in which the purchase amount had been transferred to an intermediary account, the network node 104 transfers this amount back to the buyer's account.

If, on the other hand, the network node 104 determines that the seller device 101 and the buyer device 102 are within a predefined distance from the agreed purchase location, at block 410 the network node 104 effects a transfer of the agreed purchase amount from the buyer's account to the seller's account. In an embodiment in which the purchase amount was previously transferred from the buyer account to an intermediary (or holding) account, at block 410 the network node 104 transfers the purchase amount from the intermediary account to the seller's account.

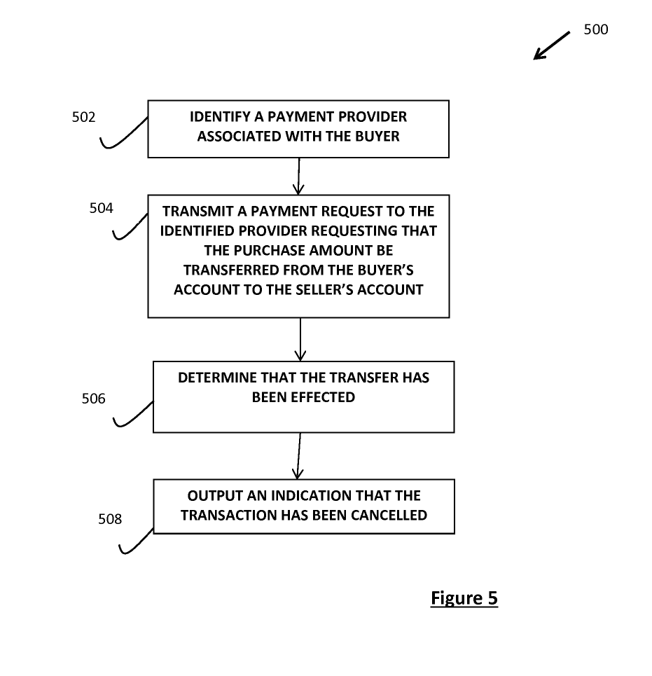

The transfer of the money from the buyer's account to the seller's account is discussed in more detail below with respect to FIG. 5.

In some embodiments, prior to effecting the transfer of the agreed purchase amount, the network node 104 determines whether an indication that the buyer wishes to continue with the transaction has been received from the buyer device 101. In the absence of any such indication within a predefined period, processing ends without completion of the transaction. As discussed above, if processing ends without completion of the transaction the network node 104 instructs the payment provider 110 to release any funds reserved in the buyer's account for the transaction. Alternatively, the network node 104 transfers money held in an intermediary account in association with the transaction back into the buyer's account.

In this manner, the buyer can check that he is happy with the object before the purchase is completed. For example, the buyer can ensure that the object is operational and/or matches the description provided in the sale offer before money is transferred to the seller. The network node 104 can therefore ensure that the buyer and seller have met at the agreed location to exchange the object for sale before transferring money, thereby providing increased security for both parties to the sale. The seller is assured that once the object has been handed over the money will be transferred as agreed, whilst the buyer is assured that he will receive the object before his money is transferred to the seller.

In an embodiment in which the agreed purchase parameters include an indication of an agreed purchase time, the network node 104 will only transfer the purchase amount if the devices are determined to be at the agreed location (or within a predefined distance thereof) at the agreed time. This further check adds an additional layer of security as it ensures that the transaction can only be completed at a time that is agreeable to both the buyer and seller. Accordingly, the parties can ensure that the transaction takes place at both a time and place with which they feel comfortable.

FIG. 5 depicts an example method of transferring the agreed purchase amount from the buyer's account to the seller's account at block 410 in accordance with an example embodiment.

At block 502 the network node 104 identifies a payment provider 110 associated with the buyer. The network node may identify the payment provider 110 in accordance with an indication of the buyer's account. Additionally or alternatively, the network node 104 may determine the payment provider 110 in accordance with any other information provided by the buyer, for example during a registration process.

At block 504 the network node 104 transmits a payment request to the payment provider 110, requesting that the agreed purchase amount be transferred from the buyer's account to the seller's account. In an embodiment in which the network 104 had previously requested the payment provider 110 to reserve the agreed purchase amount, the payment request additionally indicates that the request relates to the reserved amount.

At block 506 the network node 104 determines that the purchase amount has been transferred from the buyer's account to the seller's account. This determination may, for example, be made in accordance with a confirmation message received from the payment provider 110.

At block 508 the network node 104 then outputs an indication that the transaction has been completed. The indication of completion of the transaction may be transmitted by any suitable means to one or both of the buyer device 101 and the seller device 102. For example, the network node 104 may transmit the indication of completion by email, SMS, an ‘app’ notification or by any other suitable means.

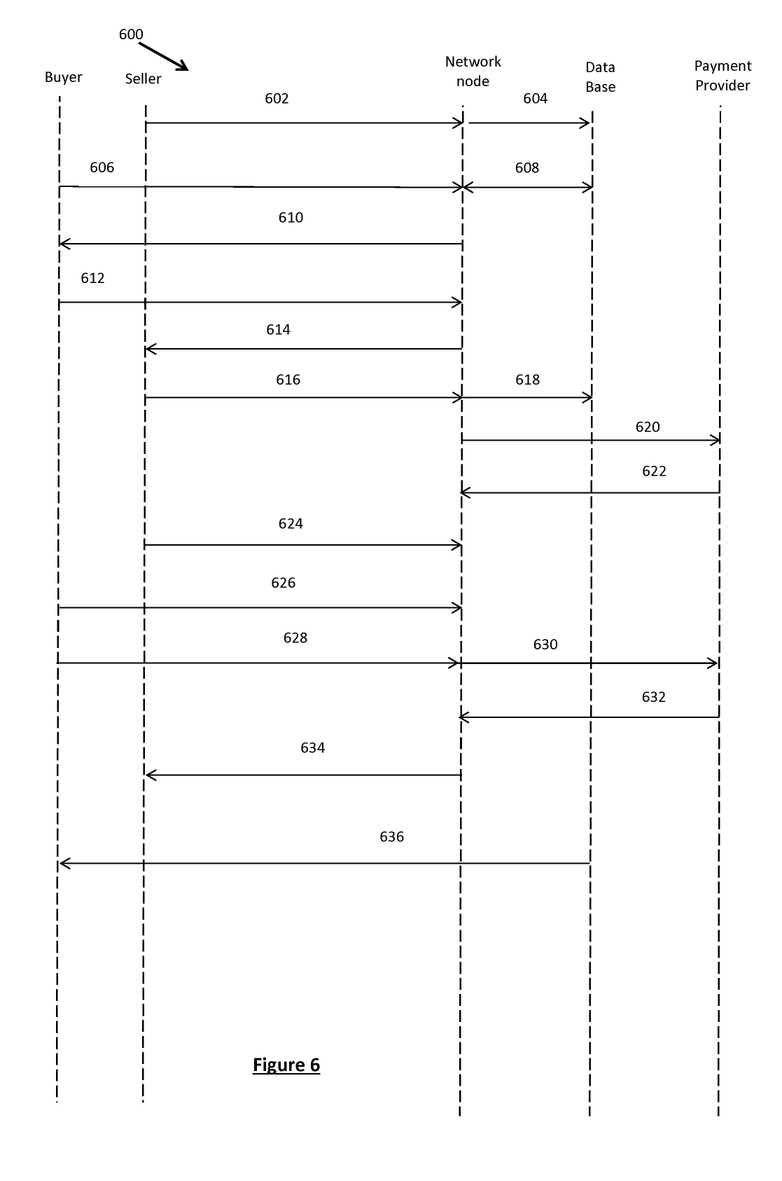

FIG. 6 depicts a sequence of communications transmitted during a transaction between two registered users in accordance with an example embodiment.

At step 602 a seller wishing to sell a bicycle transmits a sale offer from the seller device 101 to the network node 104 which operates (or is associated with) a virtual market place. The sale offer includes a photo of the bicycle; a text description of the make, age and condition of the bicycle; the price of the bicycle; details of the seller's account; and an indication that the seller is prepared to complete the sale at any point within a 10 minute walk of a specified bus route.

At step 604 the network node 104 stores and indexes information pertaining to the sale offer in the database 108. Additionally, the network node 104 outputs a selectable thumbnail image of the bicycle and its price on an interface for the virtual market place. The virtual market place interface may be a web page interface and/or an interface operated in association with application (or ‘app’) software.

At step 606, a buyer interested in purchasing a bicycle ‘logs on’ to (or navigates to, or accesses) a web page or ‘app’ interface provided by (or in association with) the network node 104. In order to identify sale offers of interest, the buyer selects one or more terms from a set of available search terms and transmits the selected search terms to the network node 104. For example, the buyer may request sale offers for bicycles within a specified price range and available for purchase at a location within a specified region.

At step 608 the network node 104 searches through the sale offers stored in the database 108 and identifies any offers that are determined to match one or more of the search terms selected by the buyer.

At step 610 the network node 104 transmits information pertaining to the matching sale offers to the buyer device 101.

At step 612 the buyer transmits a purchase request in response to one of the sale offers, the purchase request including parameters which indicate that the buyer is willing to buy the bicycle for a specified price (e.g. which may be less than the amount indicated in the sale offer); that the buyer would like to complete the transaction at a specified time and date at an indicated location along the bus route indicated by the seller; details of the buyer's account from which payment for the bicycle will be made if the transaction is completed; and an indication of a device that the buyer will use to complete the transaction.

At step 614, responsive to receiving the purchase request from the buyer device 101, the network node 104 transmits data indicative of the parameters of the purchase request to the seller.

At step 616, the seller decides that the parameters of the purchase request are acceptable and transmits a communication to the network node 104 to this effect. The communication additionally includes an indication of an identity of the seller device 101 will use to complete the transaction.

At step 618 the network node 104 stores the agreed purchase parameters in the database 108 in association with the identity of the seller device 101 and the buyer device 102.

At step 620 the network node 104 determines a payment provider 110 associated with the buyer's account and requests the payment provider 110 to confirm that the buyer's account can fund the agreed purchase and, if so, that a hold/reservation be placed on the agreed purchase amount so that this amount will remain in the buyer's account until completion of the transaction.

At step 622 the payment provider 110 transmits an indication to the network node 104 that the agreed purchase amount has been reserved in the buyer's account.

The buyer and seller meet at the agreed location at the agreed time and date to complete the transaction. At block 624 and 626 the seller device 101 and the buyer device 102 respectively transmit their locations to the network node 104 in association with an indication of their respective identities.

At step 628 the buyer device 102 transmits a communication to the network node indicating that the buyer has inspected the bicycle and would like the transaction to be completed. In this manner, the buyer can be sure that the bicycle matches the description provided by the seller before confirming that the money is to be transferred.

At step 630 the network node compares the received locations to the agreed purchase parameters stored in the database 108. Responsive to determining that both the seller device 101 and the buyer device 102 are at the agreed location at the agreed date and time, and that they buyer device has transmitted an indication that the transaction should be completed, the network node 104 instructs the payment provider 110 to transfer the reserved purchase amount from the buyer's account to the seller's account.

At step 632 the network node 104 receives a confirmation from the payment provider 110 that the funds have been transferred from the buyer's account to the seller's account.

At steps 634 and 636 the network node 104 then transmits an indication to the seller and buyer devices that the transaction has been completed. As the seller knows that the funds have been transferred, he can now confidently give the bicycle to the buyer.

The disclosure is not limited to the embodiment(s) described herein but can be amended or modified without departing from the scope of the present invention. Additionally, it will be appreciated that in embodiments of the disclosure one or more of the above-described steps may be omitted and/or performed in an order other than that described.

What is claimed is:

1. A computer-implemented method of processing a payment at a network node, the method comprising operating a processor to:
(a) identify a set of agreed purchase parameters, the agreed purchase parameters including data indicative of a purchase location, a purchase amount, a first device associated with a first user, and a second device associated with a second user;
(b) determine a first location of the first device;
(c) determine a second location of the second device; and
(d) responsive to determining that the first location and the second location are within a predefined distance from the purchase location, effecting a transfer of the purchase amount from a first account associated with the first user to a second account associated with the second user.

2. The method of claim 1, wherein the processor is operated to effect the transfer of the purchase amount only if the first location is further determined to be within a predefined distance of the second location.

3. The method of claim 1, wherein the agreed purchase parameters further include data indicative of a purchase time, and wherein the processor is operated to effect the transfer of the purchase amount only if a current time is within a predefined period of the purchase time.

4. The method of claim 1, wherein the processor is operated to effect the transfer of the purchase amount only if an indication to proceed is received from the first device.

5. The method of claim 1, wherein operating the processor to effect a transfer of the purchase amount from the first account to the second account comprises operating the processor to:
determine a payment provider associated with the first account; and
transmit, to the determined payment provider, a request for payment of the purchase amount to the second account.

6. The method of claim 1, wherein the processor is further operated to:
determine that the purchase amount has been transferred from the first account to the second account; and
output an indication that the payment has been completed.

7. The method of claim 6, wherein the processor is operated in association with an application being executed on at least one of the first device and the second device, and wherein operating the processor to output an indication that the payment has been completed comprises operating the processor to:
transmit an application notification to the at least one of the first device and the second device.

8. The method of claim 1, wherein the data indicative of a purchase location includes data indicative of at least one of:
a transport route;
a roadway; and
a geographical region.

9. The method of claim 1, wherein the agreed purchase parameters further include data indicative of the account associated with the first user and the account associated with the second user.

10. The method of claim 9, wherein the data indicative of at least one of the first account and the second account includes an account number.

11. The method of claim 10, wherein the account number is a virtual card number.

12. The method of claim 1, wherein prior to performing steps (a) to (d), the method comprises operating a processor to:
receive a sale offer from a device associated with the second user, the sale offer including data indicative of an object for sale, a requested sale amount, and a requested sale location; and
output data indicative of the received sale offer.

13. The method of claim 12, further comprising operating the processor to:
(i) receive, in response to the sale offer, a purchase request from a device associated with the first user, the purchase request including data indicative of an offer amount and a requested purchase location;
(ii) transmit the purchase request to the device associated with the second user; and
(iii) receive, from the device associated with the second user, an indication of acceptance of the purchase request, wherein at step (a) the processor is operated to identify the set of agreed purchase parameters in accordance with the accepted purchase request.

14. The method of claim 1, wherein prior to performing steps (a) to (d), the method comprises operating a processor to:
receive a set of required purchase parameters from a device associated with the first user, the required purchase parameters including data indicative of at least one of a required object, a required purchase amount, and a required purchase location;
identify at least one sale offer determined to match the set of required purchase parameters; and
transmit, to the device associated with the first user, a communication including data indicative of the identified at least one sale offer, wherein the sale offer is determined to match a set of purchase parameters if at least one of:
an identifier of an object included within the sale offer is determined to be the same as an identifier of the required object;
an amount indicated in the sale offer is within a predefined range of the required purchase amount; and
a location indicated in the sale offer is within a predefined distance of the required purchase location.

15. The method of claim 14, wherein the processor is operated in association with an application being executed on the device associated with the first user, and wherein the communication including data indicative of the identified at least one sale offer includes an application notification.

16. A network node operable to process a payment, the network node comprising a processor configured to:
(a) identify a set of agreed purchase parameters, the agreed purchase parameters including data indicative of a purchase location, a purchase amount, a first device associated with a first user, and a second device associated with a second user;
(b) determine a first location of the first device;
(c) determine a second location of the second device; and
(d) responsive to determining that the first location and the second location are within a predefined distance from the purchase location, effecting a transfer of the purchase amount from a first account associated with the first user to a second account associated with the second user.

17. A computer-readable medium comprising instructions which when executed cause a processor operating a network node to:
(a) identify a set of agreed purchase parameters, the agreed purchase parameters including data indicative of a purchase location, a purchase amount, a first device associated with a first user, and a second device associated with a second user;
(b) determine a first location of the first device;
(c) determine a second location of the second device; and
(d) responsive to determining that the first location and the second location are within a predefined distance from the purchase location, effect a transfer of the purchase amount from a first account associated with the first user to a second account associated with the second user.

18. The computer-readable medium of claim 17, wherein to effect the transfer of the purchase amount, the instructions cause the processor to effect the transfer only if the first location is further determined to be within a predefined distance of the second location.

19. The computer-readable medium of claim 17, wherein to effect the transfer of the purchase amount, the instructions cause the processor to effect the transfer only if a current time is within a predefined period of the purchase time.

20. The computer-readable medium of claim 17, wherein to effect the transfer of the purchase amount, the instructions cause the processor to effect the transfer only if an indication to proceed is received from the first device.
